(19) United States
(12) Patent Application Publication
(10) Pub. No.: US 2003/0208921 A1
(43) Pub. Date: Nov. 13, 2003

(54) Golf yardage measuring device

(76) Inventors: Allen A. Hall, Val Caron (CA); Rene P. Jacques, Val Caron (CA)

Correspondence Address: Mike M. Gauthier, 1264156 Ontario Incorporated, o/a Intel-Pro Design and Mfg., 959 Elisabella Street, Unit C, Sudbury, ON, P3A 5K1, CA

(21) Appl. No.: 10/140,158

(22) Filed: May 8, 2002

(51) Int. Cl. G01B 7/04

(52) U.S. Cl. 33/708

(57) ABSTRACT

A device utilized to measure the distance a golf cart has traveled from its last position. In the sport of golf, it is desirable to have an estimate of one's last shot in order to ascertain the distance required for the following drive. The present invention comprises; a universal mounting bracket which mounts to either wheel-struts, a flexible arm which frictionally attached within an opening in the mounting bracket, a magnetic sensor fixedly attached to one end of said flexible arm, a magnetic trigger plate having a two-faced pressure sensitive adhesive back, a battery powered pulse processor having a display readout and programming means, and wire communication means between magnetic sensor and pulse processor.

### FIELD OF THE INVENTION

The present invention relates to a device utilized to measure the distance a golf cart has traveled from its last position. In the sport of golf, it is desirable to have an estimate of one's last shot in order to ascertain the distance required for the following drive. The present invention comprises; a universal mounting bracket which mounts to either wheel-struts, a flexible arm which frictionally attached within an opening in the mounting bracket, a magnetic sensor fixedly attached to one end of said flexible arm, a magnetic trigger plate having a two-faced pressure sensitive adhesive back, a battery powered pulse processor having a display readout and programming means, and wire communication means between magnetic sensor and pulse processor.

### BACKGROUND OF THE INVENTION

For many years, inventors have attempted to provide golfers with means of measuring the distance their last drive has traveled. However, since most golf carts are manufactured in various configurations, it has been virtually impossible for any one attempt in prior art to adapt to all golf carts.

It is desirable for golfers to have this ability to measure the distance their last drive has traveled. Additionally, it is also desirable to have a measuring device that is universally adaptable to all golf carts.

The applicant is aware of several attempts in prior art to provide means of measuring the approximate distance a golf cart has traveled from the last drive. For example, reference may be had to U.S. Pat. No. 3,441,209 of Farman, issued Apr. 29, 1969, which describes an accessory device for measuring distance when a golf cart travels, utilizing an idler-type gear-driven mechanical counter system which also suggests club selection. In as much as this device provides the golfer with post-drive distance, it fails to have the universal ability to mount to any golf cart.

Another example of prior art may be had in referring to U.S. Pat. No. 3,629,557 of Lareau, issued Dec. 21, 1971, which depicts an attachment having a third wheel in communication with a worm gear linked to an odometer. This device poses an obvious problem in directional movements of the cart and may not adapt to all golf carts. Furthermore, this device proves cumbersome in handling.

Another example of prior art may be had in referring to U.S. Pat. No. 4,044,471 of Peterson, issued Aug. 30, 1977, which illustrates a measuring device having a disk-shaped wheel attachment having gears on one face at the perimeter and an axle mating gear rotatably axially in communication with a processor which converts rotations to distance. However, this device fails to compensate for wheel diameter variances from cart to cart. Furthermore, the device is not adaptable to the variety of wheel structures.

Another example of prior art may be had in referring to U.S. Pat. No. 4,532,710 of Kinney et al., issued Aug. 6, 1985, which depicts a fixed diameter wheel measuring wheel having a magnetic revolution sensor and a solar powered digital display. The device is also programmable to various wheel diameter in the event a user would prefer mounting the sensor portion to or near w cart wheel thereby avoiding the cumbersome aspects of the third wheel apparatus. However, this invention fails again to provide universal mounting ability to any golf cart.

While many prior art inventions have succeeded in providing golfers with cart distance measuring devices, none thus far have made the mounting of such devices universal to all golf carts.

### SUMMARY OF THE INVENTION

It is thus the object of the present invention to provide golfers with not only a means of accurately measuring the distance traveled by a golf cart, but to enable every golf cart to adapt this desirable function.

In one aspect of the invention, there is provided a universal mounting bracket having slots on the longer side of the bracket to allow the through-passage of conventional cable ties or the like.

In another aspect of the invention, the cable ties of the preferred embodiment of the present invention may be substituted with any suitable attaching means.

In another aspect of the invention, a two-faced adhesive membrane may be placed between the mounting bracket and the golf cart strut to prevent any possibility of displacing the mounting location of the bracket.

In another aspect of the invention, a mechanically adjustable arm may be used to replace the flexible arm of the present preferred embodiment.

In another aspect of the invention, the pulse generating means may be actuated by mechanical switching or optical laser.

In another aspect of the invention, the battery powered pulse processor may be programmable to allow the entry of a target distance from which the traveled distance is subtracted from this amount leaving the estimated balance required to travel displayed.

Accordingly, the device of the present invention allows not only the measuring of distance, it also provides universal mounting means of the sensor portion to any golf cart.

The utility of this device includes but is not limited to golf carts.

### BRIEF DESCRIPTION OF THE DRAWINGS

These and other advantages of the invention will become apparent upon reading the following detailed description and upon referring to the drawings in which:

FIG. 1 is a front elevation view of a golf cart wheel assembly having the sensor portion of the device of the present invention installed thereto.

FIG. 2 is a top plan view of a golf cart wheel assembly having the sensor portion of the device of the present invention installed thereto.

FIG. 3 is a perspective view from above of the universal mounting bracket of the device of the present invention.

FIG. 4 is a side elevation view of the universal mounting bracket of the device of the present invention.

FIG. 5 is an end elevation view of the universal mounting bracket of the device of the present invention.

FIG. 6 is a bottom plan view of the universal mounting bracket of the device of the present invention.

FIG. 7 is a perspective view from above of a golf cart wheel assembly having the sensor portion of the device of the present invention installed thereto, and a battery powered pulse processor.

FIG. 8 is an end elevation view of the universal mounting bracket of the device of the present invention as seated on a small square tubular member.

FIG. 9 is an end elevation view of the universal mounting bracket of the device of the present invention as seated on a larger square tubular member.

FIG. 10 is an end elevation view of the universal mounting bracket of the device of the present invention as seated on a small round tubular member.

FIG. 11 is an end elevation view of the universal mounting bracket of the device of the present invention as seated on a larger round tubular member.

FIG. 12 is a cross section view of the flexibly resilient extension sensor arm of the present invention.

FIG. 13 is a process flow chart outlining the key functional processes within the device of the present invention.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

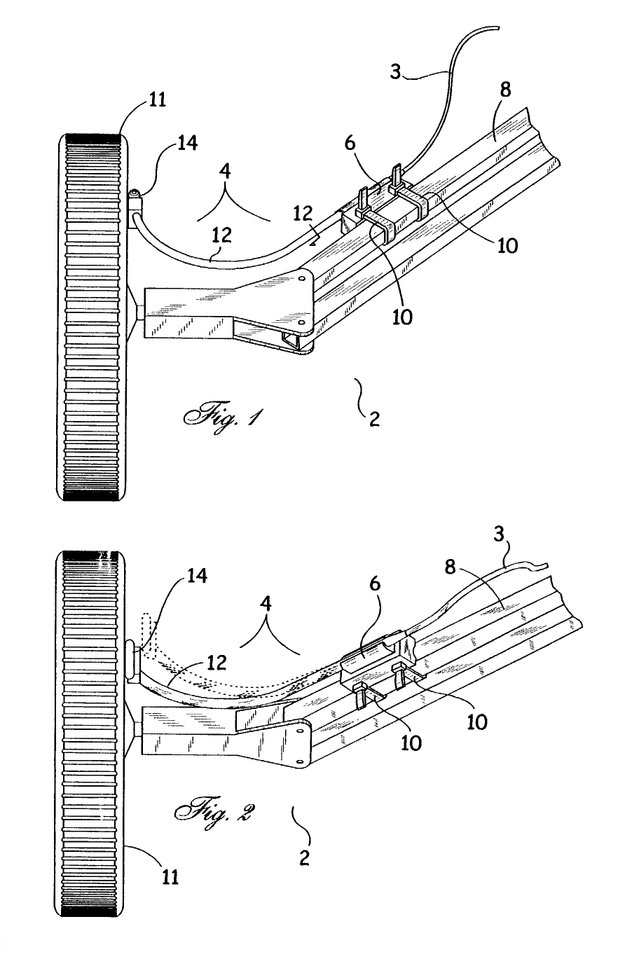

Turning to FIG. 1, which illustrates a front elevation view of a golf cart wheel assembly 2 having the sensor portion 4 of the device of the present invention installed thereto. Wherein a universal mounting bracket 6 is attached to the wheel assembly strut 8 by means of conventional cable ties 10. While golf cart wheel assemblies vary great from one another, the attachment means as described above serve to comply with any form of golf cart struts. The universal bracket 6 is now positioned to firmly secure the flexibly resilient extension sensor arm 12 having a magnetic sensor 14 at one end.

Now turning to FIG. 2, illustrating a top plan view of a golf cart wheel assembly 2 having the sensor portion 4 of the device of the present invention installed thereto. This Figure also attempts to illustrate the adjustability of the flexibly resilient extension sensor arm 12. It is therefore understood that by allowing flexibility to the flexibly resilient extension sensor arm 12, and by providing longitudinal attachment variation for the universal mounting bracket 6, that the sensor 14 can ultimately be located at relatively any location near a golf cart wheel assembly 2.

Turning to FIG. 3, which illustrates a perspective view from above of the universal mounting bracket 6. The bracket 6 consists; a lower strut-attaching portion 15 and an extension sensor arm 12 attaching portion 16. The bottom surface 20 of the lower strut-attaching portion 15 is adapted with a concave profile 21 so as to allow for both square and circular strut profiles. The side surfaces 22 of the lower strut-attaching portion 15 are traversly perforated with openings 19 so as to allow the passing of conventional cable ties 10.

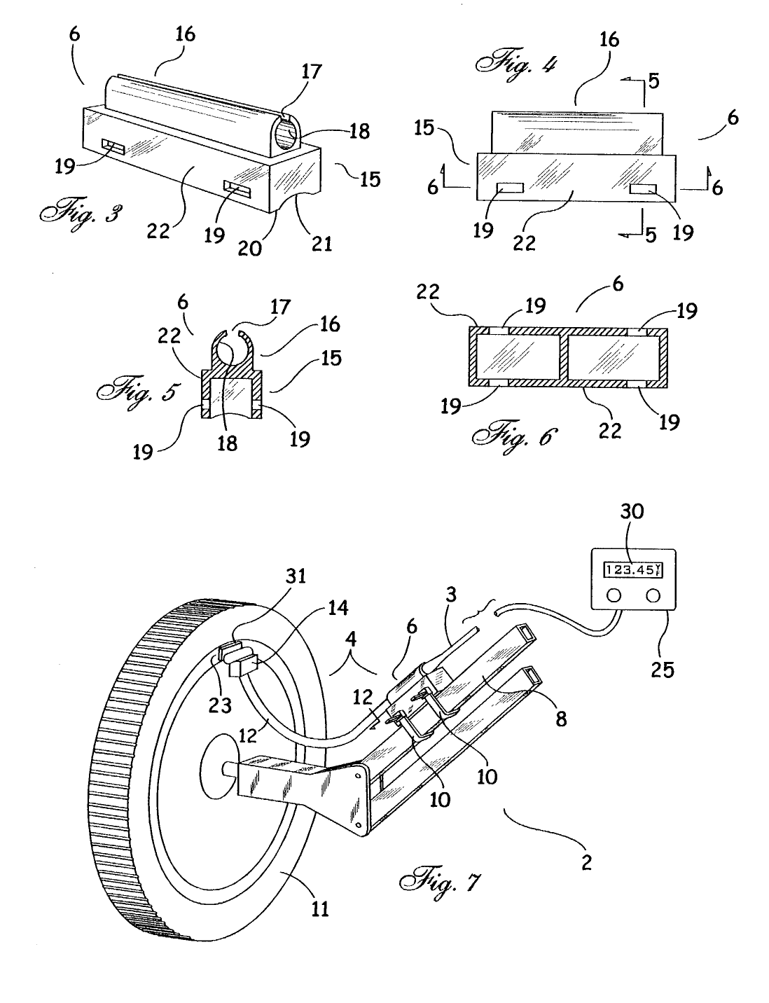

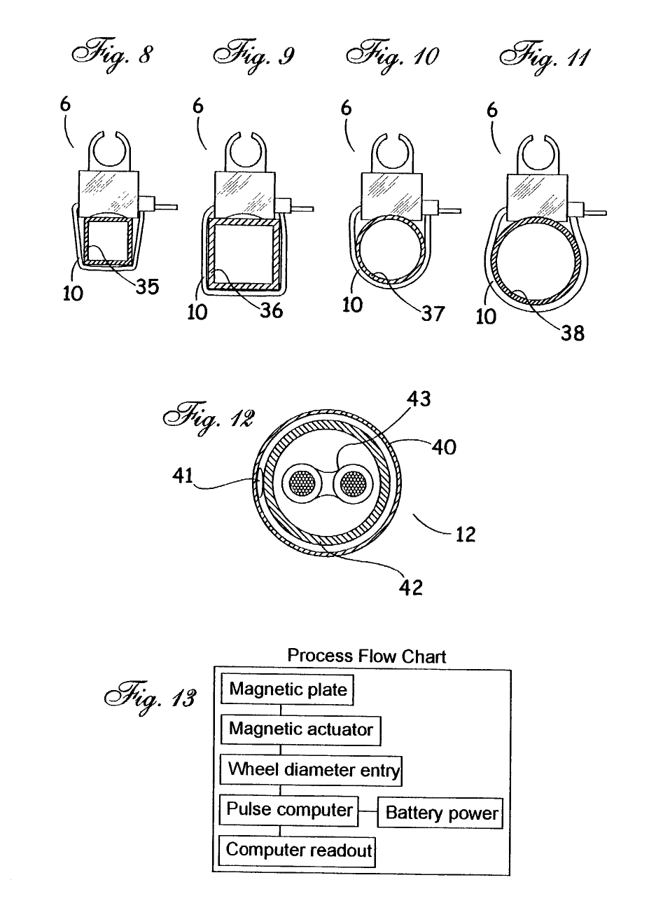

Turning now to FIG. 4, depicting a side elevation view of the universal mounting bracket 6 having; a lower strut-attaching portion 15, and an extension sensor arm 12 attaching portion 16. On both side surfaces of the lower strut-attaching portion 15, there are provided traversly perforated openings 19 so as to allow the passing of conventional cable ties 10.

In reference now to FIG. 5, depicting a cross section view of the universal mounting bracket 6, illustrating the perforations 19 which traverse the side portions 22 of the lower strut-attaching portion 15 of the universal mounting bracket 6.

FIG. 6, illustrates a cross sectional view from below of the lower strut-attaching portion 15 or the universal mounting bracket 6. The plurality of perforations 19 in the side portions 22 of the lower strut-attaching portion 15 of the universal mounting bracket 6 allow for greater attaching strength to a golf cart strut 8 and provide greater anti-rotational fixation of the universal mounting bracket 6 to the golf cart strut 8.

Now referring to FIG. 7, a perspective view of a golf cart wheel assembly 2 comprising; the sensor portion 4 of the device of the present invention installed thereto, and a battery powered pulse processor 25 having a display readout 30, programming means, and wire communication 26 between magnetic sensor 14 and pulse processor 25. The golf cart wheel 11 is adapted with a magnetic trigger plate 31 having a two-faced pressure sensitive adhesive back 23 whereby, as the wheel 11 rotates, the magnetic trigger plate 31 activates a magnetic toggle within the sensor 14 which in turn sends a pulse to the battery powered pulse processor 25 through the flexible resilient extension sensor arm 12 which is fixedly connected to conductors 26 in communication with the battery powered pulse processor 25. Accordingly, every rotation made by the golf cart wheel 11, is interpreted as a pulse by the battery powered pulse processor 25.

Turning now to FIGS. 8, 9, 10 and 11, illustrating the attachment variations of the universal mounting bracket 6 of the present invention to a small square tube 35, a larger square tube 36, a small round tube 37, and a larger round tube 38, using conventional cable ties 10.

In reference now to FIG. 12, which identifies the composition of the flexible resilient extension sensor arm 12. Said sensor arm 12 comprises; an outer flexible membrane 40, a wound wire spring 41, a flexible soft metal hollow tube 42 which has poor memory characteristics, an a conductive wire 43 within.

Lastly, turning to FIG. 13, a process flow chart identifying the flow taken by the use of the device of the present invention whereby, when a wheel is adapted with a magnetic trigger plate, the magnetic sensor is actuated and a pulse is generated. This pulse is then conveyed to a processor by means of a wire conductor passing through a flexibly resilient extension sensor arm. By programming the diameter of the wheel into the processor, each pulse is converted to a precise unit of distance. The length is then displayed on the processor and for each pulse or rotation, this unit of distance is added cumulatively to the last pulse, until reset by user.

What I claim as my invention:

1. A golf yardage measuring device comprising:
a. a universal mounting bracket having a lower rectangular portion adapted with perforations allowing the through passage of suitable connector means for fastening said mounting bracket to a golf cart wheel assembly member, an upper partially cylindrical portion having a “c” shaped profile adapted to frictionally engage its inner surface to the outer surface of a flexible member of similar size and form,
b. a flexibly resilient extension sensor arm having a magnetic sensor at one end which can be adjustably located in any location within the inner area of a golf cart wheel. Said arm having an outer flexible membrane within which is found a coiled spring-like member embracing a flexibly resilient metallic tubing having an outside diameter similar to the inside diameter of adjacent spring. The flexibly resilient metallic tubing contains a communication wire from the sensor portion to the programmable pulse processor,
c. a magnetic sensor trigger plate having a rectangular form and a two faced pressure sensitive adhesive backing for fixedly attaching to an inner surface of a golf cart wheel,
d. a programmable battery powered pulse processor having means to calculate and convert each pulse into a specified distance,

2. The universal mounting bracket of claim 1 wherein said bracket may be attached by any suitable means including but not limited to cable ties.

3. The flexibly resilient extension sensor arm of claim 1 wherein the flexibly resilient tubing may be of metallic of other material having similar properties.

4. The flexibly resilient extension sensor arm of claim 3 wherein the flexibly resilient portion of the sensor arm may be fabricated from mechanically adjustable arms.
